(19) United States
(12) Patent Application Publication
(10) Pub. No.: US 2015/0120676 A1
(43) Pub. Date: Apr. 30, 2015

(54) AUTOMATICALLY PUBLISHING COURSE OFFERINGS FOR DIFFERENT TYPES OF COURSES ACCORDING TO A PLURALITY OF POLICIES AND EDUCATIONAL INSTITUTIONS

(71) Applicant: APOLLO GROUP, INC., Phoenix, AZ (US)

(72) Inventors: NANDAKUMAR IYENGAR, San Ramon, CA (US); SAJITHKUMAR KIZHAKKINIYIL, Pleasanton, CA (US); JAYANTHISRI CHANDRASEKAR, Fremont, CA (US); NARENDER VATTIKONDA, San Jose, CA (US)

(73) Assignee: APOLLO GROUP, INC., Phoenix, AZ (US)

(21) Appl. No.: 14/065,674

(22) Filed: Oct. 29, 2013

(51) Int. Cl. G06F 17/30

(52) U.S. Cl. CPC G06F 17/30554; G06F 17/30371
USPC 707/687; 707/722

(57) ABSTRACT

A method and apparatus for automatically publishing course offerings for different types of courses according to a plurality of policies and templates is presented herein. Instructors and/or administrators for a course create course records for each course that will be offered at a particular educational institution. The course record includes, and/or is associated with, data that indicates when the course will start, what assets should be published in the course offering, what template should be used, when a course is eligible to be automatically published, and/or when a course should be published by. When courses are eligible to be published, a controller determines what priority to assign each course. The controller manages a pool of course publishing processes to publish each course according to the policies and templates defined by each course's educational institution. The controller also notifies administrators when a course publishing process fails to publish a course.

### FIELD OF THE INVENTION

The present invention relates to publishing course offerings for a plurality of courses, and more specifically, to automatically publishing course offerings for different types of courses according to a plurality of policies and educational institutions.

### BACKGROUND

A “course” is a session or series of sessions that students attend to learn a subject. A “course offering” is a collection materials related to a course. Frequently, the materials in a course offering of a course are made available online, through a server computer, to the students in the course. For example, a course offering may be a collection of one or more webpages that a student in a course may browse to access one or more videos, e-books, and assignments through Hypertext Transfer Protocol (“HTTP”) browser on a client computer.

Rules that govern when a course offering is published, and how the published course offering looks, can be complex. Further, the rules may differ based on whether the course is an online course or a traditional campus-based course. For example, an educational institution may have a policy that each online course should have a published course offering, which adheres to a particular design, at least a few hours before the online course begins. The same educational institution may have a policy that each traditional, campus-based course should have a published course offering, which adheres to a different design, weeks before the campus-based course begins.

Previously, teachers prepared course materials and sent the course materials to an administrator to publish in a course offering. Administrators would attempt to publish the course offering according to an educational institution's designs and policies. If a course offering could not be published for one reason or another, the administrator(s) could attempt to contact the course instructor(s). After a course instructor believes the issue was resolved, the instructor could ask an administrator to attempt to publish the course offering again. Such methods are time consuming for administrators and prone to errors.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### TERMS

For purposes of explanation, the following terms are defined as follows:

A “computer” means one or more computers or computing devices. For example, a computer may be one or more racked server computers, virtual machines, cloud-based servers and/or databases, desktop computers, laptop computers, mobile devices, and/or any other electronic computing devices.

A “database” means an electronic data repository that stores and/or serves data using one or more computers.

A “time” means a date and/or time. For example, a course's “start time” is the date of the course's first class and the time of that class. A time may also specify a time zone. For example, a course's start time may be “Jan. 5, 2014, at 2:00 PM Eastern Standard Time.

An “asset” means a syllabus, document, paper, e-book, audio and/or visual recording, assignment, executable file, or any other content stored electronically to teach one or more students the subject matter of a course.

A “course” is a session or series of sessions that students attend to learn a subject. Different sections that teach the same subject are treated herein as different courses. For example, two separately taught sections of “Physics 101” are each regarded as a separate course.

An “online course” means a course, workshop, or discussion group that where interactions primarily occur online.

A “traditional course” means a course, workshop, or discussion group where interactions are primarily not online.

A “late course” means a course that is not published by a target publication time.

A “split course” is a course that is created because enrollment in another course is too high. For purposes of illustrating a clear non-limiting example, assume the following facts:
a course, designed for twenty-five students, is created;
before the first day of class the course is published; and
fifty students enroll and are present when the course starts;

In response to the surplus of students in the course, a split course is created. Twenty-five of the original fifty students are assigned to the new split course. Since the split course has already started, and since the split course is unpublished, the split course is a late course.

A “student” means a student, observer, or any other person that enrolls in a course.

An “instructor” means a teacher, aid, group leader, or anyone else that supports one or more students in a course.

An “administrator” means any person that monitors or supervises one or more courses and/or instructors. An administrator may be an instructor. Administrators include technical support staff that monitor and/or maintain one or more portions of a system that publishes courses.

A “course offering” is a collection of assets for a course. Typically, a course offering is downloaded from a server to a student's client computer, and presented to the student by the client computer in a particular visual format. The particular format may have a particular look and feel that is based on a template. For example, a course offering may be a collection of one or more webpages that a student may browse to access one or more assets in the course through Hypertext Transfer Protocol (“HTTP”) browser. A course offering and/or the assets in a course offering need not be presented in an HTTP browser. For example, a course offering and/or one or more of its assets may be available through a mobile application running on a mobile device.

A “template” defines the look and feel of a course offering. Accordingly, a template may determine the juxtaposition of the assets in a course offering. A template need not define a layout in which all of the assets in a course offering are presented at once. For example, a template may define several webpages, each of which may contain, link to, and/or reference one or more of the assets available in a course offering, and which may be requested by a student through client computer.

“Publishing a course” means provisioning one or more assets for the course and generating a course offering for the course.

A course is “published” if the assets assigned to the course are provisioned and a course offering for the course is generated.

“Provisioning an asset” means verifying that the asset is available and/or safe to be downloaded. Provisioning may include acquiring, virus checking, reformatting, and/or any other process to make an asset available to one or more students in a course. For example, provisioning a video may involve downloading a video from a reference (for example, a link), scanning the video for viruses, and converting the video into one or more formats for one or more devices. Also for example, provisioning an e-book may involve downloading the e-book, redacting particular portions that are not required for a particular course, scanning the non-redacted portions for viruses, and/or storing the e-book in one or more formats on a server computer accessible by one or more students on one or more computers.

The “modality” for a course means the rules that relate to publication of a course. Such rules may define when the course is a candidate to be automatically published and/or when the course should be published. For example, the modality for a traditional course may indicate that the traditional course is a candidate for automatic publication three days and four hours before the course's start time. Additionally or alternatively, the modality for the traditional course may indicate that the course should be published no later than three days before the course's start time. Additionally or alternatively, if the course is a late course, the modality for the course may indicate that the course is a candidate for automatic publishing four hours after the course record corresponding to the late course is created. The four hours may be used by an instructor or administrator to update assets before the course is published. Additionally or alternatively, the modality for a course may be different based on the educational institution that the course is associated with. For example, an online course for associated with a first educational institution may have a different modality than a course for a second educational institution, even if the two courses have the same start time. Additionally or alternatively, the modality for an online course may indicate that an online course may be published any time after an instructor designates that the online course is ready to be published, but no later than a particular time before the online course's start time.

### BRIEF DESCRIPTION OF THE DRAWINGS

In the drawings:

FIG. 1 illustrates a block diagram of a system for automatically publishing courses, in an example embodiment.

FIG. 2 illustrates a process to automatically publishing a plurality of courses, in an example embodiment.

FIG. 3 illustrates a block diagram of a course record, in an example embodiment.

FIG. 4 illustrates a process for publishing a course, in an example embodiment.

FIG. 5 illustrates a block diagram of a system for automatically publishing courses, in an example embodiment.

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The larger the variety courses that are offered to students, the greater the flexibility the students have when determining which courses to take and from which schools. For example, students that live within a close proximity to a particular school may prefer to take traditional courses at a local campus. Other students may wish to take online courses that allow students to live far from the campus of the school whose courses they are attending.

Part of determining which courses to take may depend on the course offerings published for each course. Course offerings provide promotional materials for prospective students to determine whether to register for a course. Course offerings also provide learning materials for registered students to read, watch, listen to, and/or complete. Accordingly, publishing courses in a timely manner that adheres to each school's policies and templates is important.

Administrators may spend an enormous amount of time publishing course offerings for different types of courses, with different start times, and for different educational institutions in one or more time zones. Administrators are also susceptible to human error. Accordingly, a system and method of automatically publishing course offerings for different types of courses according to a plurality of policies and templates is presented herein.

As discussed in detail herein, instructors and/or administrators for a course create course records for each course that will be offered at a particular educational institution. The course record includes, and/or is associated with, data that indicates when the course will start, what assets should be published in the course offering, what template should be used, when a course is eligible to be automatically published, and/or when a course should be published by. When courses are eligible to be published, a controller determines what priority to assign each course. The controller manages a pool of course publishing processes to publish each course according to the policies and templates defined by each course's educational institution. The controller also notifies administrators when a course publishing process fails to publish a course.

### Topology

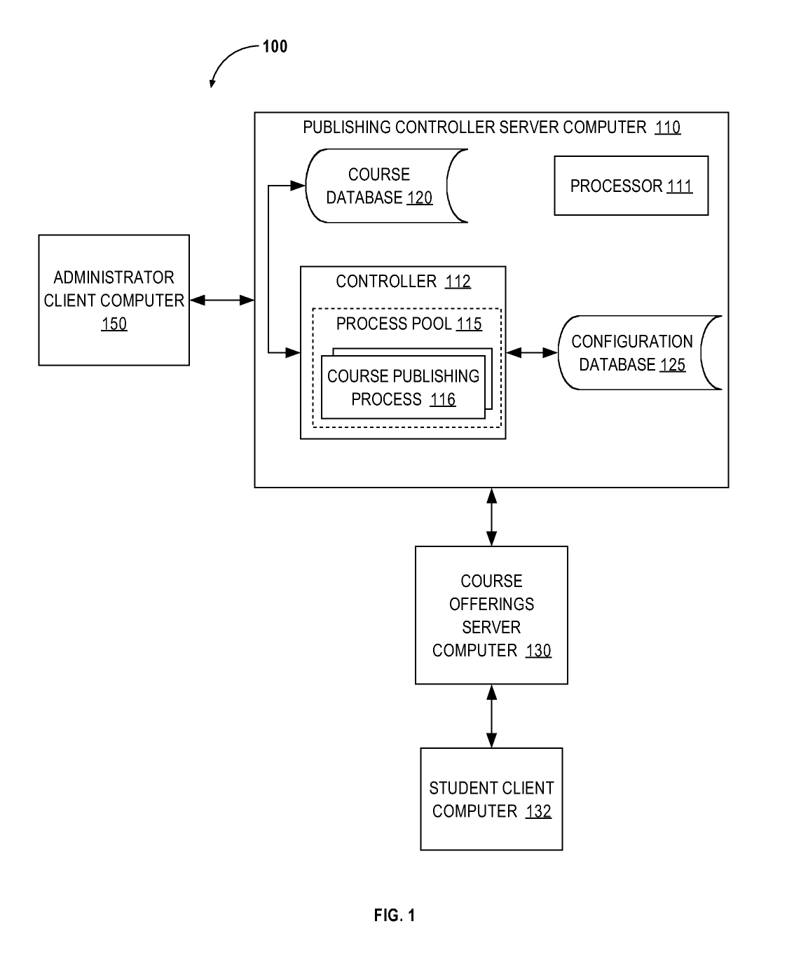

FIG. 1 illustrates a block diagram of a system for automatically publishing courses, in an example embodiment. While FIG. 1 illustrates a particular embodiment for purposes of illustrating a clear example, other embodiments may omit, add to, reorder, and/or modify any of the elements shown. In FIG. 1, system 100 comprises publishing server 110, processor 111, controller 112, course publishing process 116, configuration database 125, course database 120, offerings server 130, student client computer 132, administrator client computer 150, and administrator client computer 160. While controller 112, process pool 115, course publishing process 116, configuration database 125, and course database 120 are illustrated as if executed and/or stored on publishing server 110, each may be executed and/or stored on one or more separate computers. Furthermore, while publishing server 110 and offerings server 130 are illustrated as separate computers, publishing server 110 and offerings server 130 may be executed and/or stored on the same computer(s). Furthermore, in an embodiment, administrator client computer 150 and administrator client computer 160 may be the same computer.

Each computer and component in FIG. 1 may be communicatively coupled to the other computers or components, either directly or indirectly. The components discussed herein need not be stored or executed on the same computer and/or local area network. For example, publishing server 110, course database 120, offerings server 130, or any other computer or component herein, may be part of, or hosted by, one or more services, such as a cloud-based computing service.

### Publishing Server

Publishing server 110 is a computer that comprises processor 111, controller 112, configuration database 125, and course database 120. The processor 131 may comprise a CPU that is configured to execute the processes and operations described in detail herein for publishing server 110, or any of its components.

### Course Publishing Process Pool

Process pool 115 is a pool of course publishing processes. Process pool 115 is managed by controller 112. In FIG. 1 process pool 115 is illustrated as if solely residing on a single computer: publishing server 110. However, process pool 115 may include processes executing on the same computer(s) running controller 112, and/or one or more other computers. Additionally or alternatively, process pool 115 may comprise one or more processes executed on one or more cloud computer server computers and/or services.

### Course Publishing Process

Course publishing process 116 publishes one or more courses onto offerings server 130. A course publishing process, such as course publishing process 116, can be executed on the same computer as one or more other course publishing processes, or on one or more other computers.

### Course Publishing Controller

Controller 112 maintains a number of publishing instances based on the number of courses that need to be published within a particular amount of time. If no courses need to be published within a particular amount of time, controller 112 may terminate each course publishing process in process pool 115. Alternatively, controller 112 may maintain a base number of course publishing processes in process pool 115. If a number of course publishing processes currently being executed are insufficient to publish a particular number of courses within a particular amount of time, controller 112 may instantiate one or more additional course publishing processes. If more course publishing processes are instantiated than currently needed, controller 112 may terminate one or more course publishing processes. Methods for maintaining process pool 115 are discussed in detail below.

### Course Database

Course database 120 is a database that stores course records, each of which corresponds to a course. Course database 120 may be a service, relational database, flat file, and/or other storage medium and/or data structure capable of storing and/or searching course records.

### Course Records

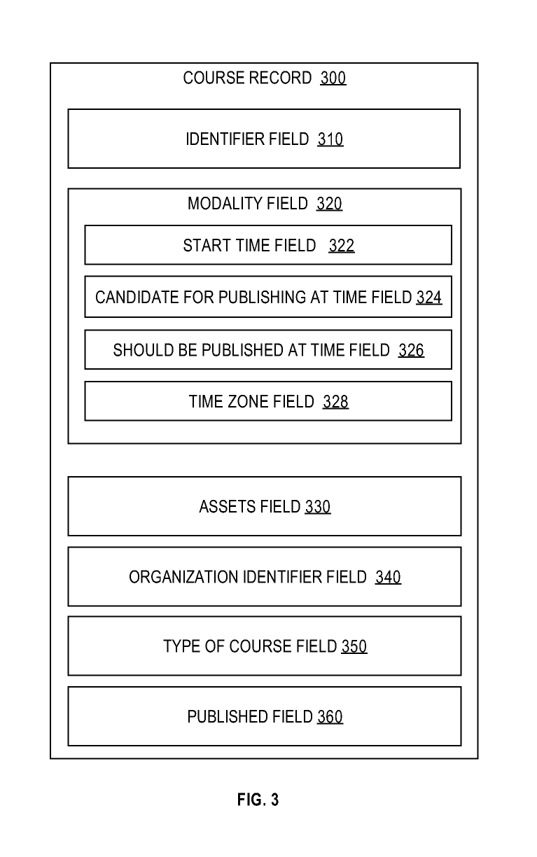

FIG. 3 illustrates a block diagram of a course record, in an example embodiment. While FIG. 3 illustrates a particular embodiment of a course record for purposes of illustrating a clear example, other embodiments may omit, add to, reorder, and/or modify any of the elements shown. In FIG. 3, course record 300 includes identifier field 310, modality-related fields 320, assets field 330, educational institution identifier field 340, type of course field 350, and published field 360. For convenience of expression, a field that “includes data,” means that the field includes the data, the field contains a reference to the data, and/or the data is in some way derived from or associated with course record 300. For example, assets field 330 may contain references to locations where assets are stored. Also for example, start time field 322 may include the start time of a course; however, candidate for publishing at time field 324 may be determined and associated with course record 300 at run time, based on one or more rules stored in a configuration database 125 and/or the time stored in start time field 322.

A course record may include identifying information. For example, identifier field 310 includes data that identifies the course that corresponds to course record 300. Educational institution identifier field 340 includes data that identifies the educational institution associated with the corresponding course (for example, a department, a college, and/or a business). Additionally or alternatively, educational institution identifier field 340 may include data that indicates the educational institution's policies and/or templates for publishing courses associated with the educational institution.

A course record may identify what type of course the corresponding course is. For example, type of course field 350 includes data that indicates what type of course the corresponding course is: an online course or a traditional course. While online courses and traditional courses are discusses herein, the methods and system presented herein may be with other types of courses (for example, domestic courses and/or foreign courses).

A course record may identify one or more assets that should be included in the course offering when the corresponding course is published. For example, assets field 330 includes data for one or more assets.

A course record may indicate whether the course has been published. For example, published field 360 may include data that indicates whether the corresponding course is published.

A course record may include the modality of the corresponding course. As mentioned above, the modality of a course indicates rules relating to the publication of the course. Depending on what those rules are for a given course, a course may have multiple modality-related fields, as explained hereafter.

### Modality-Related Fields

As mentioned above, one or more fields of a course record may relate to the modality of the corresponding course. In the example illustrated in FIG. 3, modality-related fields 320 includes start time field 322, auto-publish-time field 324, target-publication-time field 326, and time zone field 328. In an embodiment, a modality field need not include all the fields included in modality-related fields 320.

Turning now to the fields in modality-related fields 320, start time field 322 includes data that indicates the start time for the corresponding course. Time zone field 328 includes data that indicates the time zone the course is assigned. For example, if classes for a traditional course are held in New York City, then time zone field 328 may be assigned the local time zone: Eastern Standard Time. Also for example, if a teacher of an online course lives in California and the course is offered through a college based in Arizona, then time zone field 328 may be assigned the local Arizona time zone: Mountain Standard Time without Daylight Saving Time. In an embodiment the start time field 322 and time zone field 328 are the same field, and include both the start time and the assigned time zone.

Auto-publish-time field 324 includes data that indicates the time at which a course is a candidate to be automatically published. For example, a school may have a policy that a course should not be published earlier than a particular amount of time before the course starts. Auto-publish-time field 324 includes data that indicates the earliest time at which a course is a candidate to be automatically published according to the policy.

Additionally or alternatively, an instructor or administrator may set the auto-publish-time field 324 to a “ready” state for a course when the instructor or administrator has finished preparing the course. An administrator may have finished preparing a course when all the assets for the course have been gathered and/or identified. Additionally or alternatively, the instructor or administrator may set the auto-publish-time field 324 to the current time. Additionally or alternatively, the instructor or administrator may set the auto-publish-time field 324 to a time that the instructor or administrator has determined to be an acceptable time for the course to be published.

Auto-publish-time field 324 may be determined at run time based on one or more rules. Auto-publish-time field 324 may be a time interval based on start time field 322, target-publication-time field 326, and/or time zone field 328.

Target-publication-time field 326 includes data that indicates the time the corresponding course should be published at. A course that is not published by the time indicated in target-publication-time field 326 is a late course. Target-publication-time field 326 may be determined at run time based on one or more rules. Additionally or alternatively, target-publication-time field 326 may be set by an instructor or administrator. Target-publication-time field 326 may be a time interval based on start time field 322, auto-publish-time field 324, and/or time zone field 328.

### Configuration Database

Configuration database 125 is a database that stores rules that define when courses are candidates to be automatically published, when courses should be published, and/or what publication priority courses should have. These rules may be used, for example, to determine the values that populate the modality-related fields of individual course records, described above.

As an example of a publication rule, configuration database 125 may include data for a rule that indicates online courses should be published at least nine hours before the start time of the online courses, based on the online courses' assigned time zone. Based on this rule, an online course that starts at 10:00 PM Eastern Standard Time should published by 1:00 PM Eastern Standard Time on the same day.

As another example of a publication rule, configuration database 125 may include data for a rule that indicates traditional courses should be published at least three days and four hours before the start time of the traditional courses, based on the traditional courses' assigned time zone.

Still further for example, configuration database 125 may include data for a rule that indicates that late courses should have priority to be published over courses that are not late.

Course database 120 may be a service, relational database, flat file, configuration file, and/or other storage medium and/or data structure capable of storing and/or retrieving rules defining when courses should be published and/or what priority courses should be given.

### Institution-Specific Rules

Configuration database 125 may store different rules for different educational institutions. For example, assume two colleges at the same university offer online courses. Configuration database 125 may store a rule for a first college that indicates online courses associated with the first college should be published ten hours before starting. Configuration database 125 may store a rule for a second college that indicates online courses associated with the second college should be published two weeks before starting.

Furthermore, configuration database 125 may store a rule for the first college that indicates online courses associated with the first college are candidates for automatic publishing seventy-two hours before starting. Configuration database 125 may store a rule for a second college that indicates online courses associated with the second college are candidates for automatic publishing two-weeks and three days before starting. Further still, configuration database 125 may store distinct rules for any number of unrelated educational institutions.

### Offerings Server

Offerings server 130 is a computer, such as a webserver, that serves or otherwise makes available, one or more course offerings for one or more courses. Students may access course offerings stored on offerings server 130 through student client computer 132.

### Student Client Computer

Student client computer 132 is a computer used by one or more students. Students may browse and/or retrieve course offerings or portions of course offerings stored on offerings server 130. For example, a student enrolled in a course may use an HTTP browser running on student client computer 132 to browse the course offering for the course. Also for example, the student may download one or more assets, published in the course offering onto student client computer 132.

### Administrator Client Computer

Administrator client computer 150 is a computer used by one or more administrators. An administrator may create and/or update a course record in course database 120 for a corresponding course. For example, an instructor may use an HTTP browser, running on administrator client computer 150, to upload data to course database 120. The data may designate a particular e-book to be included in the course's course offering.

### Process Overview for Publishing Courses

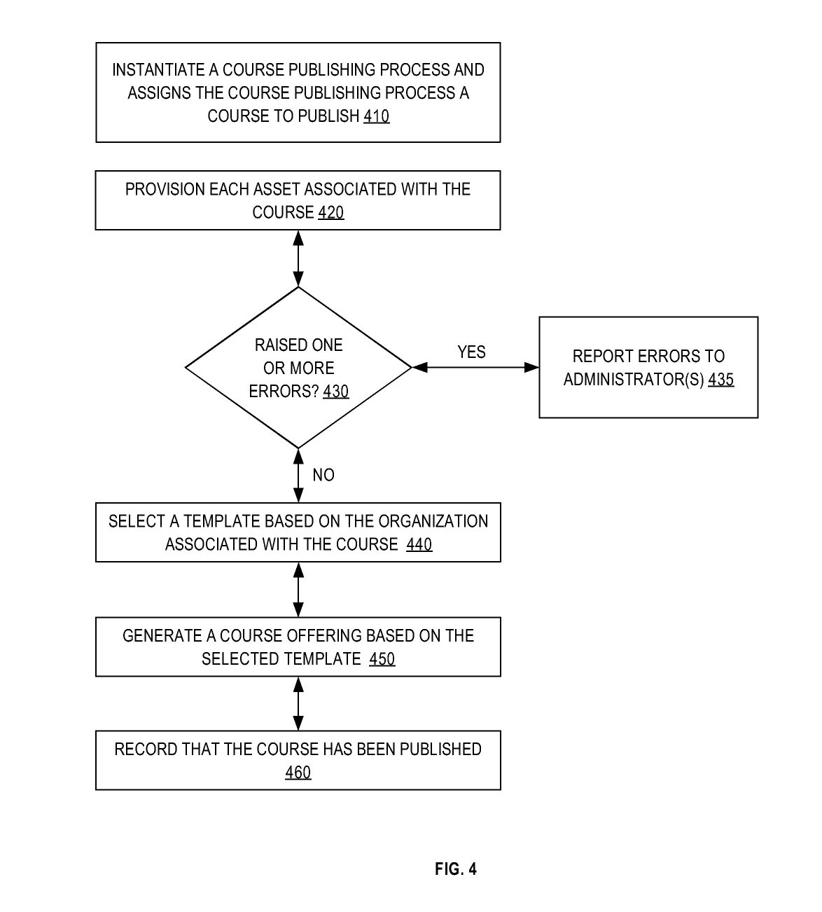

FIG. 4 illustrates a process for publishing a course, in an example embodiment. While FIG. 4 illustrates example steps according to an embodiment, other embodiments may omit, add to, reorder, and/or modify any of the steps shown. For purposes of illustrating a clear example, FIG. 4 may be described with reference to FIG. 1 and FIG. 3, but using the particular arrangements illustrated in FIG. 1 and FIG. 3 is not required.

Now turning to FIG. 4, in step 410, a course publishing controller instantiates a course publishing process and assigns the course publishing process a course to publish. For example, controller 112 may instantiate course publishing process 116 and assign course publishing process 116 a course to publish. Controller 112 may provide course publishing process 116 with the corresponding course record or a portion of the course record. Additionally or alternatively, course publishing process 116 may query course database 120 for the corresponding course record or a portion of the course record and/or data associated with the course.

In step 420, the course publishing process provisions each asset associated with the course. For purposes of illustrating a clear example, assume the following facts:
the course record indicates that a video is an asset, which is located on a first server computer, should be included in the course offering; and
the course record indicates that an e-book is an asset, which is located on a second server computer, should be included in the course offering.

Accordingly, course publishing process 116 requests and downloads the video from the first server computer and the e-book from the second server computer. Course publishing process 116 checks both the video and the e-book for viruses. Course publishing process 116 saves the video in one or more formats on offerings server 130. Course publishing process 116 saves the e-book in one or more formats on offerings server 130. Course publishing process 116 may be instructed as to which format(s) each asset should be converted to, and/or stored in, based on data stored in configuration database 125, data stored in the course record, and/or any other configuration. Course publishing process 116 may be instructed as to which server computer(s) each asset should be stored based on data stored in configuration database 125, data stored in the course record, and/or any other configuration.

If an asset is used in more than one course, subsequently the asset need not be re-provisioned for each course. If a course is a split course, and the split course does not contain assets that are not contained the in the course it was split from, then the assets in the split course need not be re-provisioned.

In step 430, the course publishing process determines whether an error was raised or occurred during step 420. For example, if course publishing process 116 was not able to download the video and/or the e-book, then course publishing process 116 raises an error and proceeds to step 435. Additionally or alternatively, if an asset contained a virus or the asset file was corrupt, then course publishing process 116 raises an error and proceeds to step 435. Additionally or alternatively, if controller 112 determines course publishing process 116 exited prematurely. Accordingly, controller 112 proceeds to step 435. Additionally or alternatively, if course publishing process 116 experiences an error, then course publishing process 116 reports the error to controller 112; either course publishing process 116 or controller 112 then proceeds to step 435.

In step 435, the course publishing process reports errors to administrator(s). For example, course publishing process 116 sends a notification to the course's instructor indicating an error occurred. Additionally or alternatively, the notification may suggest one or more ways to fix the error. The notification may be sent as an email, text message, status update, and/or any other method of conveying to an administrator that an error occurred. Additionally or alternatively, an administrator may be notified after the course has failed to be published more than a threshold number of times. Additionally or alternatively, the error may be recorded in an error log. An administrator may review the error log to fix the assets and/or the course record accordingly.

In step 440, the course publishing process selects a template based on the educational institution associated with the course. For purposes of illustrating a clear example, assume the following facts:
the course is taught by a professor in the school of engineering;
the school of engineering has a template that all course offerings corresponding to courses taught by the school of engineering should adhere to; and
the educational institution identifier field, in the course record that corresponds to the course, identifies the school of engineering as the educational institution through which the course is offered.

Accordingly, course publishing process 116 selects the school of engineering's template to generate the course's course offering. Additionally or alternatively, instead of identifying an educational institution, the course record may include data that indicates which template of a plurality of templates to use. Additionally or alternatively, if no template is defined for an educational institution, or if no educational institution is identified, then course publishing process 116 may publish the course according to a fallback or generic template. Additionally or alternatively, course publishing process 116 may raise and/or return an error. Accordingly, either course publishing process 116 or controller 112 may then proceed to step 435.

In step 450, the course publishing processes generates a course offering based on the selected template. For example, course publishing process 116 generates a webpage on offerings server 130 with a layout defined by the selected template. The web page may embed, link to, or otherwise make available the video and the e-book to one or more students using student client computer 132.

In step 460, the course publishing process records that the course has been published. For example, course publishing process 116 sets published field 360 in the course record to indicate that the corresponding course is published. Additionally or alternatively, course publishing process 116 may return control, or otherwise signal, to controller 112 that publishing is complete. Controller 112 sets published field 360 in the course record to indicate that the corresponding course is published.

### Process for Automatically Publishing Courses

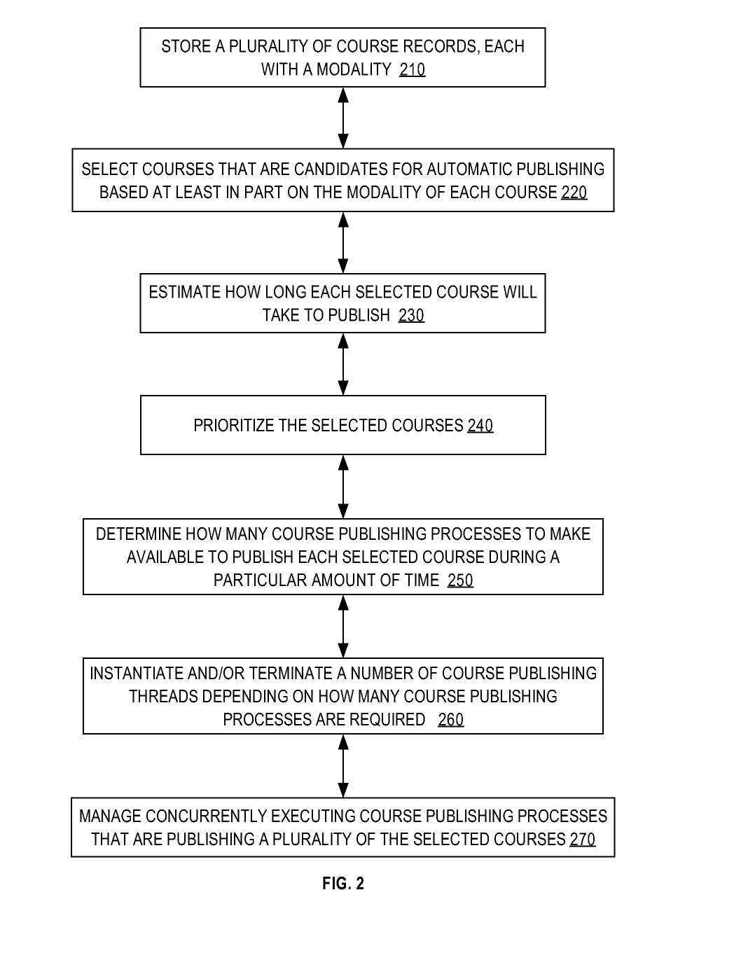

FIG. 2 illustrates a process to automatically publishing a plurality of courses, in an example embodiment. While FIG. 2 illustrates example steps according to an embodiment, other embodiments may omit, add to, reorder, and/or modify any of the steps shown. For purposes of illustrating a clear example, FIG. 2 may be described with reference to FIG. 1, but using the particular arrangement illustrated in FIG. 1 is not required in other embodiments.

Now turning to FIG. 2, in step 210, one or more administrators store a plurality of course records, each with a modality. For example, each instructor teaching a course creates a course record for the course the instructor is teaching. The course record indicates the start time for the corresponding course and includes the time zone the instructor assigned to the course. Controller 112 calculates and updates the course record with the time to store in the auto-publish-time field, and the time to store in the target-publication-time field, based on the course's start time, the course's time zone, and the rules defined in configuration database 125.

In step 220, controller 112 selects courses that are candidates for automatic publishing based at least in part on the modality of each course. For example, controller 112 selects all course records from course database 120 that are not marked as published and that should have been published already (for example, late courses). Controller 112 also selects all course records that are not marked as published and include a time in the auto-publish-time field that is less than or equal to a current time, adjusting for time zones. Controller 112 may select both groups of course records with a single query to course database 120.

### Estimating the Time to Publish a Course

In step 230, controller 112 estimates how long each selected course will take to publish. For example, controller 112 may monitor one or more course publishing processes to determine the average time it takes a course to be published. One or more other statistics, such as median, variance, and/or probability distribution functions, may be used to estimate how long each course will take to publish.

Controller 112 may determine how long a course will take to publish based on the number of assets that are associated with the course. For example, if each asset takes thirty seconds to provision on average, then controller 112 may estimate that a course with four assets will take two minutes to publish.

Controller 112 may determine how long a course will take to publish based on the type of each asset associated with the course. For controller 112 purposes of illustrating a clear example, assume the following facts:
a course includes two assets: a video and an e-book;
videos are provisioned in two minutes on average; and
e-books are provisioned in one minute on average.

Accordingly, controller 112 estimates the course will take three minutes to publish. Examples of different types of assets include, but are in no way limited to, videos, images, executable files, e-books, assignments, and/or tests. Additionally or alternatively, controller 112 may determine how long a course will take to publish based on any attribute associated with the course and/or any attribute associated with any asset associated with the course.

Controller 112 may determine how long a course will take to publish based on one or more machine learning algorithms, such as a neural network, a genome-based algorithm, and/or a regression algorithm. For example, controller 112 may use one or more factors already discussed and/or listed below with a neural network to estimate the how long a course will take to publish. The following is a non-limiting list of factors that may be used to estimate how long a particular asset will take to provision and thus, how long the associated course will take to publish:
the size of an asset on disk;
the uncompressed size of an asset;
the author(s) and/or source(s) of each asset (assets from a first source may already be scanned for viruses, and assets from a second source may not);
the server computers and/or services the asset is currently located on;
the observed throughput from each server computer or service;
the number of versions and/or formats to be generated for each asset; and/or
any other attributes of, or related to, an asset.

### Prioritizing Each Selected Course

In step 240, controller 112 prioritizes the selected courses. Controller 112 may prioritize a first course over a second course based on the modality of each course and/or any of the other factors discussed herein.

Controller 112 may prioritize one type of course over another type of course. For purposes of illustrating a clear example, assume that online courses are candidates for publishing nine hours before starting, whereas traditional courses are candidates for publishing three days before starting. Since students will have less time to review a course offering before the online course starts than to review a course offering before a traditional course starts, then controller 112 may prioritize online courses over traditional courses. Also for example, controller 112 may prioritize late courses over any other unpublished course.

Controller 112 may prioritize courses that should have already been published over courses that are merely candidates to be automatically published. For example, if a first course has not started, but should have been published, controller 112 may prioritize the first course over a second course that is merely a candidate for automatically publishing.

Controller 112 may prioritize courses based on the start time of each course. For example, if a two courses have not been published and the first course starts in ten hours and the second course starts in eleven hours, then controller 112 may prioritize the first course over the second course.

Controller 112 may prioritize courses based on the types of assets assigned to each course. For purposes of illustrating a clear example, assume the following facts:
publishing a first course requires provisioning a recorded lecture;
publishing a second course requires provisioning an e-book;
provisioning the recorded lecture is estimated to take more time than provisioning an e-book.

Controller 112 may prioritize the first course over the second course because provisioning the first course's asset is estimated to take longer than provisioning the second course's asset.

Controller 112 may prioritize courses based on the how much time each course is estimated to take to be published. For example, if two courses are candidates to be published, but the first course is estimated to take two hours to publish and the second course is estimated to take one hour to publish, then controller 112 may prioritize the first course over the second course. For purposes of illustrating a more complex example, assume the following facts:
a first course starts in ten hours;
a second course starts in nine hours;
the first course is estimated to take two hours to publish; and
the second course is estimated to take half an hour to publish.

Because the first course is estimated to be published eight hours before starting and the second course is estimated to be published eight and a half hours before starting, controller 112 may prioritize the first course over the second course.

Controller 112 may prioritize courses based on a combination of factors discussed herein. For purposes of illustrating a clear example assume the follow facts:
a first course is a traditional course that should have been published already, but will not start for another seventy-two hours;
a second course is an online course that is merely a candidate to be published;
the second course will start in ten hours;
the second course is estimated to take one hour to publish;
a third course is an online course that is merely a candidate to be published;
the third course will start in eleven hours;
the third course is estimated to take three hours to publish; and
online courses should be published nine hours before the online course's start time.

Because the estimated publishing time indicates that the third course will not actually be published until after it should have already published, controller 112 may prioritize the third course over the second course. Because the third course is an online course and because the third course starts earlier than the first course, controller 112 may prioritize the third course over the first course. Because the second course is an online course and because second course will start sooner than the first course, controller 112 may prioritize the second course over the first course.

### Determining the Number of Course Publishing Processes to Instantiate or Terminate

In step 250, controller 112 determines how many course publishing processes to make available to publish each selected course during a particular amount of time. Controller 112 may determine how many course publishing processes should be instantiated or terminated based on one or more factors:
the number of courses selected in step 220;
an interval in which the selected courses should be published by;
the number of processors and/or processing cores available to execute course publishing processes;
the speed of each processor or processing core;
the bandwidth to download one or more assets;
the amount of memory available for each processor or processing core;
what types of assets need to be provisioned; and/or
the amount of memory available to each available processor;
the number of course publishing processes already instantiated.

For purposes of illustrating clear examples, assume the following facts:
controller 112 repeats step 220 (selecting courses to automatically publish) each hour;
100 courses are currently selected to be published;
each selected course is estimated to take five minutes to publish;
controller 112 manages three distributed-memory computers each with two, single-core coprocessors; and
each coprocessor performs at approximately the same speed.

In a first example, controller 112 determines that the currently selected 100 courses will take an estimated 8.3 hours to publish with a single process. Accordingly, controller 112 determines to make nine course publishing processes available to publish the 100 courses within an hour.

In a second example, assume the same facts and the following additional facts:
the assets for each of the 100 courses are primarily small text documents;
each course publishing process, on average, spends four out of the five minutes downloading assets, primarily because of latency, not bandwidth; and
each course publishing process, on average, spends almost one out of the five minutes processing each downloaded asset.

Because the assets for four course publishing processes are expected to be processed in the same amount of time it takes for one course publishing process to download all the required assets for a course, controller 112 determines to make sixteen course publishing processes available.

If the bottle neck for publishing courses is on the speed at which the processors can execute the course publishing processes, then, controller 112 need not instantiate more processes than processors. Thus, controller 112 may determine to make one course publishing process available for each core.

In a third example, assume the same facts in the first example and the following additional facts:
the assets for each of the 100 courses are primarily video recordings;
each video recording requires a substantial amount of memory; and
the assets for two courses cannot fit into the memory available on one of the three computers.

Thus, a substantial amount of thrashing between virtual memory and main memory occurs if two course publishing processes were executing on the same computer using separate coprocessors. Accordingly, controller 112 determines to make one course publishing process available on each computer since additional course publishing processes will result in time penalties while memory is thrashing.

### Instantiating and Terminating Course Processes

In step 260, controller 112 instantiates and/or terminates a number of course publishing threads depending on how many course publishing processes are required. For example, in step 250, if controller 112 determines that additional course publishing processes should be made available, then controller 112 may instantiate one or more course publishing processes in process pool 115. Similarly, if in step 250, controller 112 determines that fewer course publishing processes should be made available then controller 112 may terminate one or more course publishing processes in process pool 115.

Controller 112 may instantiate one or more course publishing processes on one or more particular computers. For example, using the third example above, controller 112 may instantiate one course publishing process on each computer. Also for example, if a first computer can process more course publishing processes than a second computer, then controller 112 may instantiate additional course publishing processes on the first computer.

Controller 112 may terminate one or more course publishing processes on one or more particular computers. For example, using the third example above, assume two course publishing processes are currently running on a first computer of the three computers. Accordingly, controller 112 may terminate one of the two course publishing processes on the first computer.

### Managing Concurrently Executing Course Publishing Processes

In step 270, controller 112 manages concurrently executing course publishing processes that are publishing a plurality of the selected courses. For example, controller 112 may instruct each course publishing process to publish a particular selected course based on priority. When a course publishing process finishes publishing a course, the course publishing process queries controller 112 for the next highest priority course to publish.

Controller 112 may instruct the operating system, on which a process is executing, to execute the process with a higher priority while the process is publishing a particular high priority course. Additionally or alternatively, controller 112 may instruct the operating system, on which a process is executing, to execute the process with a lower priority while the process is publishing a lower priority course.

Controller 112 may spawn a new course publishing processes upon determining that a previously executed course publishing process was terminated. For example, each spawned course publishing process may be instantiated and assigned a course to publish. When the spawned course publishing process finishes publishing the assigned course, course publishing process may terminate and/or return one or more values to controller 112. Accordingly, when controller 112 detects a publishing process has terminated, controller 112 may spawn a new course publishing process and assign it the next highest priority unpublished course. Also for example, if a course publishing process incurs an error, such as a segmentation fault, and is terminated, then controller 112 may spawn a new course publishing process. Controller 112 need not assign the new course publishing process the same course that caused the previous course publishing process to terminate. However, controller 112 may send a notification to an administrator indicating that a particular course was not published.

Controller 112 may repeat steps 250 and 260 and adjust the number of course publishing processes in process pool 115 as needed. For example, if controller 112 determines that courses are being published faster than previously estimated, then controller 112 terminates one or more course publishing processes. If controller 112 determines that courses are being published slower than previously estimated, then controller 112 instantiates additional course publishing processes.

Controller 112 may return to step 220 to begin publishing additional courses. In re-visited step 220, controller 112 may re-select courses that were not published because of an error or some other reason. Controller 112 returns to step 220 to select additional courses that are candidates to be automatically publishing at the beginning of each period regardless of whether the current selected courses have all been published. Accordingly, controller 112 prioritizes the newly selected course with the currently selected unpublished course, determines the number of course publishing process to maintain in process pool 115, and manages the concurrently executing course publishing processes.

### Segregated Topology and Processes for Automatically Publishing Courses

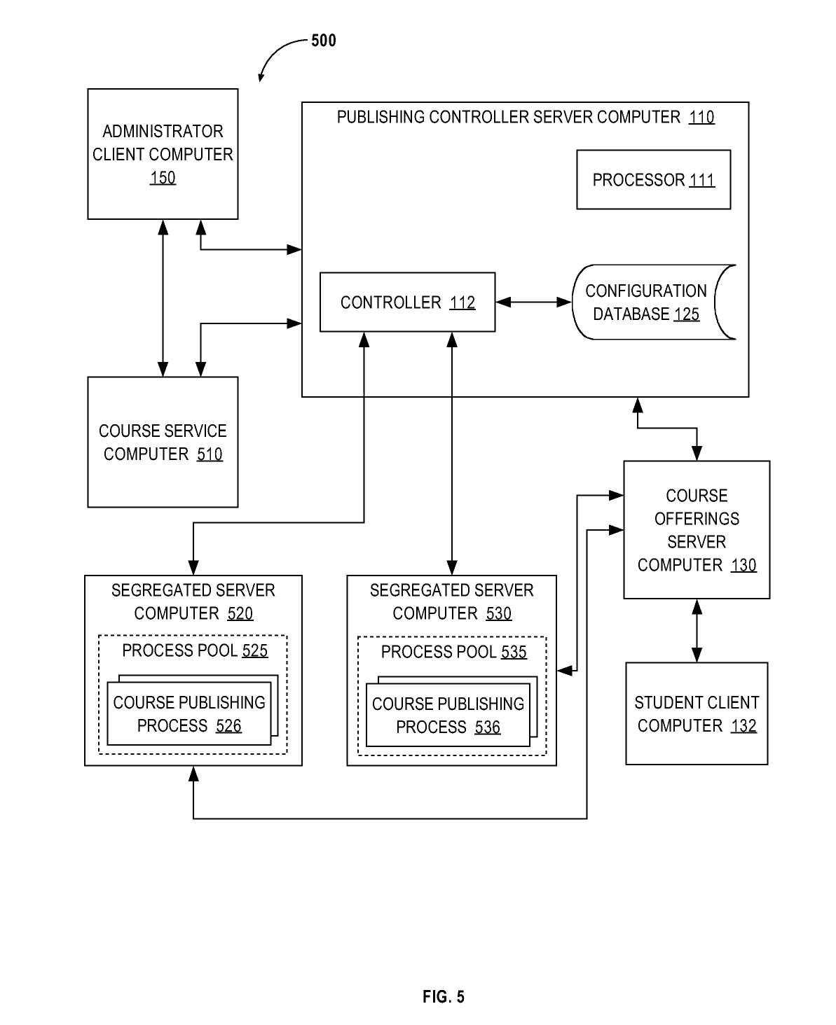

FIG. 5 illustrates a block diagram of a system for automatically publishing courses in a segregated environment, in an example embodiment. While FIG. 5 illustrates an embodiment for purposes of illustrating a clear example, other embodiments may omit, add to, reorder, and/or modify any of the elements shown. In FIG. 5, system 500 includes a system for automatically publishing courses similar to system 100. System 500, however, comprises course service computer 510, segregated server computer 520, process pool 525, course publishing process 526, segregated server computer 530, process pool 535, and course publishing process 536.

Course service computer 510 may be a database, service, and/or other data repository that returns information regarding one or more courses. Additionally course service computer 510 stores assets, or references to assets, for each course. Additionally, administrator client computer 150 is communicatively coupled to course service computer 510. One or more administrators manage courses and course assets on course service computer 510 through administrator client computer 150.

Segregated server computer 520 and segregated server computer 530 are each a server computer. Segregated server computer 520 and segregated server computer 530 each maintain a process pool, process pool 525 and process pool 535, respectively.

Each process pool includes one or more course publishing processes. Process pool 525 includes at least one course publishing process: course publishing process 526. Process pool 535 includes at least course publishing process: course publishing process 536.

Process pool 525 and process pool 535 are each similar to process pool 115, in FIG. 1; however, course publishing processes in process pool 525 exclusively publish courses that belong to a first group with a first set of rules and/or templates defined in configuration database 125. Course publishing processes in process pool 535 exclusively publish courses that belong to a second group with a second set of rules and/or templates defined in configuration database 125. In this section a group is a set of one or more courses that adhere to the same rules to define the modality of each course. For example, a group may be defined as all online courses for a particular school, if the modality of all online courses in the particular school are determined using the same rule(s). Also for example, a group may be defined as all traditional courses that are published using the same template. A course record may include a group identifier field. In an embodiment, educational institution identifier field 340 in record 300 is a group identifier field.

Executing course publishing processes on a segregated server computer increases efficiency. For example, if all the course publishing processes on a segregated server computer exclusively publish courses according to the same template, then the segregated server computer need not have additional templates stored in memory. Courses publishing in the same group may be more likely to share the same assets since group are commonly divided by educational institutions, rules, and/or templates.

Controller 112 manages course publishing processes in process pool 525 and process pool 535 according to the methods discussed above. However, controller 112 manages the load on segregated server computer 520 separately from segregated server computer 530. For example, if the load on a segregated server computer 520 surpasses a threshold, controller 112 may instantiate a new segregated server computer with a new process pool for the same group. Controller 112 may load balance the courses being published for the group associated with segregated server computer 520 between processes executed on both segregated server computer 520 and the new segregated server computer.

Additionally or alternatively, if the load on a segregated server computer, such as the new segregated server computer in the previous paragraph falls below a threshold, then controller 112 may terminate the new segregated server computer and the course publishing processes executing on the new segregated server computer. Additionally or alternatively, controller 112 may wait for one or more of the course publishing processes executing on the new segregated server computer to finish publishing any currently assigned unpublished courses before terminating either the one or more course publishing processes or the new segregated server computer.

Additionally or alternatively, a pre-defined number of course publishing processes are allowed on each server computer. For example, if controller 112 determines more course publishing processes than the pre-defined number should be instantiated, then controller 112 instantiates a new segregated server computer with a new process pool for the same group, as discussed above.

Additionally or alternatively, each segregated server computer is a segregated cluster of one or more server computers executed on a cloud-based and/or elastic server computer system. If the load on a segregated cluster of server computers exceeds a threshold, then controller 112 adds another server computer to the segregated cluster of server computers. Accordingly, the process pool for a segregated cluster of sever computers spans each of the server computers in the segregated cluster. Furthermore, if the load on the segregated cluster of server computers falls below a threshold, then controller 112 server computer removes a server computer from the segregated cluster of server computers. Additionally, controller gracefully terminates the course publishing processes executing on the removed server computer before the server computer is removed from the segregated cluster of server computers.

In an embodiment, controller 112 includes a plurality controller processes that run, each of which are assigned to a particular group. Accordingly, each of the one or more controller processes carry out the methods described above exclusively for a particular group using one or more segregated server computers.

The process in FIG. 2 may be modified using the embodiment illustrated in FIG. 5. For example, step 220 may be modified using the embodiment illustrated in FIG. 5, controller 112 sends one or more requests for a first set of courses associated with a group that have started within a first time period and a second set of courses that will start within a second time period. For purposes of illustrating a clear example, assume the following facts:
all courses in a group are candidates to be published seventy-two hours before the start time of each course;
each hour controller 112 sends a first request to course service computer 510 for all courses in the group that have started within the last twenty-four hours;
each hour controller 112 sends a second request to course service computer 510 for all courses in the group that will start within the next ninety-six hours;

Because controller 112 requests courses that have already started within the last twenty-four hours, controller 112 will receive data identifying any late courses associated with the group that started within the last twenty-four hours. Because controller 112 sends the first request each hour, controller 112 will make several attempts to publish each unpublished course associated with the group, which gives administrators time to make changes or fix errors if needed. Retrieving the courses that will start within the next ninety-six hours includes all courses associated with the group that will start within three days regardless of the time zone assigned to the course.

For each course returned, controller 112 discards any course that is not a candidate for automatic publication based on the time zone associated with the course. For purposes of illustrating a clear example, assume the following facts:
a course is returned that is scheduled to start on Jan. 5, 2014, at 5:00 PM Pacific Standard Time; and
the time according to controller 112 is Jan. 2, 2014, at 6:00 PM Eastern Standard Time.

Controller 112 discards the course, because the course is not a candidate for automatic publication. The course is seventy-four hours from starting, not seventy-two or fewer hours from starting after factoring the course's time zone and the controller's time zone.

In an embodiment, course service computer 510 does not include data that indicates whether a course has been published or not. Accordingly, for the remaining courses, controller 112 sends one or more requests to offerings server 130 to determine which courses are published. Controller 112 discards each course that is published and selects each remaining unpublished course. Controller 112 may process the remaining unpublished courses as discussed above.

In an embodiment, course service computer 510 exclusively includes course assigned to a particular group. Thus, in an embodiment, system 500 includes a plurality of course service computers, one for each group. Similarly, in an embodiment, offerings server 130 exclusively includes the course offerings for a particular group. Thus, in an embodiment, system 500 includes a plurality of course offerings server computers, one for each group.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

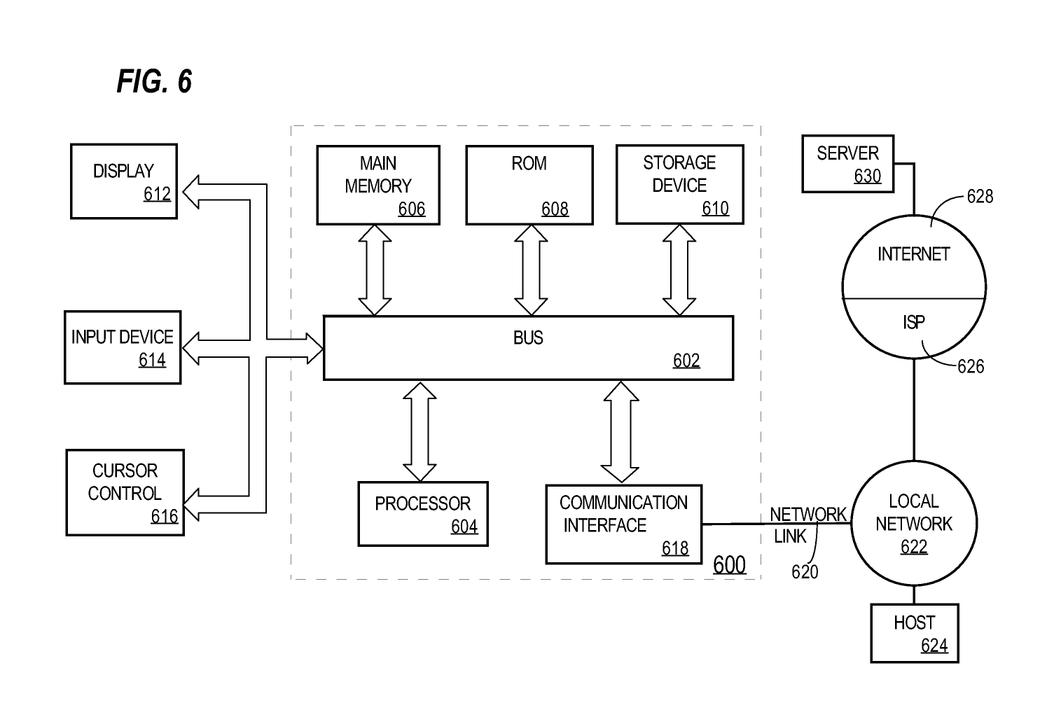

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
electronically storing a plurality of course records;
wherein each course record of the plurality of course records corresponds to a course that has not been published;
wherein each course record of the plurality of course records is associated with a modality;
selecting, for automatic publication, one or more courses that are currently unpublished but that are ready to be published;
wherein the step of selecting is performed based, at least in part, on the modalities associated with one or more course records that correspond to the one or more courses; and
automatically publishing the one or more courses.

2. The method of claim 1, wherein:
the modality associated with each course record includes a start time at which a corresponding course is scheduled to start; and
selecting the one or more courses that are currently unpublished comprises:
for each course record of the plurality of course records, determining a particular time that the corresponding course should be published by, based on the start time included in the modality of the course record; and
for each course record of the plurality of course records, selecting the corresponding course if a current time is equal to or greater than the particular time for the course record.

3. The method of claim 1, wherein:
the modality associated with each course record includes a publishing ready time at which a corresponding course is ready to be published; and
selecting the one or more courses that are currently unpublished comprises:
for each course record of the plurality of course records, determining a particular time that the corresponding course may be published by, based on the publishing ready time included in the modality of the course record; and
for each course record of the plurality of course records, selecting the corresponding course if a current time is equal to or greater than the particular time for the course record.

4. The method of claim 1, wherein:
the modality, associated with each course record, includes a time zone to which a corresponding course is set; and
selecting the one or more courses that are currently unpublished is based, at least in part, on the time zone included in the modality of a corresponding course record.

5. The method of claim 1, wherein automatically publishing the one or more courses that are currently unpublished comprises:
estimating an amount of time that each course of the one or more courses is expected to take to publish;
spawning one or more course publishing processes, such that a total number of course publishing processes running are estimated to be sufficient to finish publishing each course of the one or more courses within a time window.

6. The method of claim 1, wherein automatically publishing the one or more courses that are currently unpublished comprises:
estimating an amount of time that each course of the one or more courses is expected to take to publish;
terminating one or more course publishing processes, such that a total number of course publishing processes running are estimated to be sufficient to finish publishing each of the one or more courses within a time window.

7. The method of claim 1, wherein:
the modality, associated with each course record, includes a start time at which a corresponding course is scheduled to start; and
automatically publishing the one or more courses that are currently unpublished comprises:
assigning a priority to each course of the one or more courses based on the start time included in the modality of a corresponding course record; and
publishing each course in the one or more courses in an order based, at least in part, on the priority assigned to each course.

8. The method of claim 1, wherein:
a course type is associated with each course record; and
automatically publishing the one or more courses that are currently unpublished comprises:
assigning a priority to each course of the one or more courses based on the course type associated with a corresponding course record; and
publishing each course in the one or more courses in an order based, at least in part, on the priority assigned to each course.

9. The method of claim 1, further comprising:
electronically storing one or more late course records;
wherein each late course record of the one or more late course records corresponds to a late course of one or more late courses, which has already started, but has not been published;
wherein selecting the one or more courses that are currently unpublished, but that are ready to be published, comprises selecting the one or more late course records;
wherein publishing the one or more courses includes publishing the one or more late courses.

10. The method of claim 9, wherein:
the one or more courses that are currently unpublished are a plurality of unpublished courses;
automatically publishing the plurality of unpublished courses that are currently unpublished comprises:
assigning a priority to each course of the plurality of unpublished courses based on whether the course is late or not;
wherein each course, of the plurality of unpublished courses, that is late is given a higher priority than each course of the plurality of unpublished courses that is not late;
publishing each course in the plurality of unpublished courses in an order based, at least in part, on the priority assigned to each course.

11. The method of claim 1, wherein:
each course in the one or more courses that are currently unpublished is associated with an educational institution of a plurality of educational institutions;
automatically publishing each course in the one or more courses comprises:
selecting a template, of a plurality of templates, for each course in the one or more courses, based at least in part on the educational institution that is associated with the course;
generating a course offering for each course in the one or more courses, wherein the course offering for the course is generated according to the template, which defines a look and feel of the course offering.

12. The method of claim 1, wherein automatically publishing the one or more courses that are currently unpublished comprises:
validating each course of the one or more courses;
for each course of the one or more courses:
determining whether the course is valid;
in response to determining that the course is valid, generating a course offering for the course;
in response to determining that the course is not valid:
generating an error message indicating that the course was not published;
sending the error message to an administrator.

13. One or more non-transitory computer-readable media storing instructions which, when executed by one or more processors, cause performance of a method comprising:
electronically storing a plurality of course records;
wherein each course record of the plurality of course records corresponds to a course that has not been published;
wherein each course record of the plurality of course records is associated with a modality;
selecting, for automatic publication, one or more courses that are currently unpublished but that are ready to be published;
wherein the step of selecting is performed based, at least in part, on the modalities associated with one or more course records that correspond to the one or more courses; and
automatically publishing the one or more courses.

14. The one or more non-transitory computer-readable media of claim 13, wherein:
the modality associated with each course record includes a start time at which a corresponding course is scheduled to start; and
selecting the one or more courses that are currently unpublished comprises:
for each course record of the plurality of course records, determining a particular time that the corresponding course should be published by, based on the start time included in the modality of the course record; and
for each course record of the plurality of course records, selecting the corresponding course if a current time is equal to or greater than the particular time for the course record.

15. The one or more non-transitory computer-readable media of claim 13, wherein:
the modality associated with each course record includes a publishing ready time at which a corresponding course is ready to be published; and
selecting the one or more courses that are currently unpublished comprises:
for each course record of the plurality of course records, determining a particular time that the corresponding course may be published by, based on the publishing ready time included in the modality of the course record; and
for each course record of the plurality of course records, selecting the corresponding course if a current time is equal to or greater than the particular time for the course record.

16. The one or more non-transitory computer-readable media of claim 13, wherein:
the modality, associated with each course record, includes a time zone to which a corresponding course is set; and
selecting the one or more courses that are currently unpublished is based, at least in part, on the time zone included in the modality of a corresponding course record.

17. The one or more non-transitory computer-readable media of claim 13, wherein automatically publishing the one or more courses that are currently unpublished comprises:
estimating an amount of time that each course of the one or more courses is expected to take to publish;
spawning one or more course publishing processes, such that a total number of course publishing processes running are estimated to be sufficient to finish publishing each course of the one or more courses within a time window.

18. The one or more non-transitory computer-readable media of claim 13, wherein automatically publishing the one or more courses that are currently unpublished comprises:
estimating an amount of time that each course of the one or more courses is expected to take to publish;
terminating one or more course publishing processes, such that a total number of course publishing processes running are estimated to be sufficient to finish publishing each of the one or more courses within a time window.

19. The one or more non-transitory computer-readable media of claim 13, wherein:
the modality, associated with each course record, includes a start time at which a corresponding course is scheduled to start; and
automatically publishing the one or more courses that are currently unpublished comprises:
assigning a priority to each course of the one or more courses based on the start time included in the modality of a corresponding course record; and
publishing each course in the one or more courses in an order based, at least in part, on the priority assigned to each course.

20. The one or more non-transitory computer-readable media of claim 13, wherein:
a course type is associated with each course record; and
automatically publishing the one or more courses that are currently unpublished comprises:
assigning a priority to each course of the one or more courses based on the course type associated with a corresponding course record; and
publishing each course in the one or more courses in an order based, at least in part, on the priority assigned to each course.

21. The one or more non-transitory computer-readable media of claim 13, the method further comprising:
electronically storing one or more late course records;
wherein each late course record of the one or more late course records corresponds to a late course of one or more late courses, which has already started, but has not been published;
wherein selecting the one or more courses that are currently unpublished, but that are ready to be published, comprises selecting the one or more late course records;
wherein publishing the one or more courses includes publishing the one or more late courses.

22. The one or more non-transitory computer-readable media of claim 21, wherein:
the one or more courses that are currently unpublished are a plurality of unpublished courses;
automatically publishing the plurality of unpublished courses that are currently unpublished comprises:
assigning a priority to each course of the plurality of unpublished courses based on whether the course is late or not;
wherein each course, of the plurality of unpublished courses, that is late is given a higher priority than each course of the plurality of unpublished courses that is not late;
publishing each course in the plurality of unpublished courses in an order based, at least in part, on the priority assigned to each course.

23. The one or more non-transitory computer-readable media of claim 13, wherein:
each course in the one or more courses that are currently unpublished is associated with an educational institution of a plurality of educational institutions;
automatically publishing each course in the one or more courses comprises:
selecting a template, of a plurality of templates, for each course in the one or more courses, based at least in part on the educational institution that is associated with the course;
generating a course offering for each course in the one or more courses, wherein the course offering for the course is generated according to the template, which defines a look and feel of the course offering.

24. The one or more non-transitory computer-readable media of claim 13, wherein automatically publishing the one or more courses that are currently unpublished comprises:
validating each course of the one or more courses;
for each course of the one or more courses:
determining whether the course is valid;
in response to determining that the course is valid, generating a course offering for the course;
in response to determining that the course is not valid:
generating an error message indicating that the course was not published;
sending the error message to an administrator.
